(19) United States
(12) Patent Application Publication
(10) Pub. No.: US 2023/0275682 A1
(43) Pub. Date: Aug. 31, 2023

(54) COMMUNICATION DEVICE, COMMUNICATION METHOD, COMMUNICATION SYSTEM AND COMMUNICATION PROGRAM

(71) Applicant: NIPPON TELEGRAPH AND TELEPHONE CORPORATION, Tokyo (JP)

(72) Inventors: Takamitsu TOCHINO, Musashino-shi, Tokyo (JP); Hirotaka UJIKAWA, Musashino-shi, Tokyo (JP); Hirotaka NAKAMURA, Musashino-shi, Tokyo (JP)

(73) Assignee: NIPPON TELEGRAPH AND TELEPHONE CORPORATION, Tokyo (JP)

(21) Appl. No.: 18/015,435

(22) PCT Filed: Jul. 15, 2020
(86) PCT No.: PCT/JP2020/027563

§ 371 Date: Jan. 10, 2023

(51) Int. Cl. H04J 14/08

(52) U.S. Cl. CPC H04J 14/08

(57) ABSTRACT

A communication device includes: a communication unit that is connected to an optical ring network, conducts optical signal communication by time-division multiplexing, and receives a control signal for controlling an optical signal transmission timing from a master communication device; and a determination unit that determines the master communication device not to be operating properly and causes the subject communication device to operate as a new master communication device, in a case where the control signal is not received in a predetermined period. Thus, even in a case where the master device cannot operate properly, a slave device operates as the master device, so that the system operation can be continued.

### TECHNICAL FIELD

The present invention relates to a technology for conducting communication by performing time-division multiplexing on optical signals in an optical ring network that forms a communication system.

### BACKGROUND ART

A conventional optical ring network system conducts communication by multiplexing optical signals having wavelengths allocated beforehand to a plurality of optical transmission devices connected to an optical ring network by an optical add-drop multiplexer (OADM) technology (see Non Patent Literature 1, for example).

On the other hand, there is a known optical burst ring network technology for transmitting optical signals by time-division multiplexing, instead of OADM. By this technology, one optical transmission among a plurality of optical transmission devices connected to an optical ring network operates as a master device, and the other optical transmission devices operate as slave devices. The master device transmits an allocation signal and a search signal, to control the data transmission timings of the slave devices including the subject device, and register a slave device newly connected to the optical ring network. In this manner, the plurality of optical transmission devices connected to the optical ring network can conduct communication by perform time-division multiplexing on optical signals by the optical burst ring network technology.

### CITATION LIST

### Non Patent Literature

Non Patent Literature 1: Sakamaki et al., “Optical Switch Technology for Obtaining More Flexible Optical Nodes”, NTT Technology Journal, November 2013 (https://www.ntt.co.jp/journal/1311/files/jn201311016.pdf)

### SUMMARY OF INVENTION

### Technical Problem

By the optical burst ring network technology, however, in a case where the master device cannot operate properly due to a failure or the like, the data transmission timing and the like are not controlled, and therefore, it is difficult to continue the system operation.

The present invention aims to provide a communication device, a communication method, a communication system, and a communication program that enable continuation of a system operation by causing a slave device to operate as a new master device in a case where the master device that controls a plurality of optical transmission devices connected to an optical ring network that conducts communication by performing time-division multiplexing on optical signals cannot operate properly.

### Solution to Problem

A communication device according to the present invention includes: a communication unit that is connected to an optical ring network, conducts optical signal communication by time-division multiplexing, and receives a control signal for controlling an optical signal transmission timing from a master communication device; and a determination unit that determines the master communication device not to be operating properly and causes the subject communication device to operate as a new master communication device, in a case where the control signal is not received in a predetermined period.

The present invention also relates to a communication method that is used in a communication system in which a plurality of communication devices is connected by an optical ring network, one of the communication devices being a master communication device, the other ones of the communication devices being slave communication devices. The master communication device transmits a control signal for controlling the transmission timings to transmit optical signals to a plurality of the slave communication devices by time-division multiplexing. Each slave communication device transmits an optical signal to the optical ring network on the basis of the transmission timing of the control signal received from the master communication device, and, in a case where the control signal is not received in a predetermined period, determines the master communication device not to be operating properly, and causes the subject communication device to operate as a new master communication device.

The present invention also relates to a communication system in which a plurality of communication devices is connected by an optical ring network, one of the communication devices being a master communication device, the other ones of the communication devices being slave communication devices. The master communication device transmits a control signal for controlling the transmission timings to transmit optical signals to a plurality of the slave communication devices by time-division multiplexing. Each slave communication device transmits an optical signal to the optical ring network on the basis of the transmission timing of the control signal received from the master communication device, and, in a case where the control signal is not received in a predetermined period, determines the master communication device not to be operating properly, and causes the subject communication device to operate as a new master communication device.

Further, a communication program according to the present invention causes a computer or an integrated circuit to perform the processes that are performed by the determination unit of the communication device described above.

### Advantageous Effects of Invention

A communication device, a communication method, a communication system, and a communication program according to the present invention enable continuation of a system operation by causing a slave device to start operating as the new master device, in a case where the master device that controls a plurality of optical transmission devices connected to an optical ring network that conducts communication by performing time-division multiplexing on optical signals cannot operate properly.

### BRIEF DESCRIPTION OF DRAWINGS

FIG. 1 is a diagram illustrating an example of an optical ring network system according to an embodiment.

FIG. 2 is a diagram illustrating an example of allocation signal communication.

FIG. 3 is a diagram illustrating an example of search signal communication.

FIG. 4 is a diagram illustrating an example configuration of an optical transmission device operating as a slave device.

FIG. 5 is a diagram illustrating an example process of switching to the master device.

FIG. 6 is a diagram illustrating an optical ring network system of a comparative example.

FIG. 7 is a diagram illustrating the configuration of optical transmission devices of the comparative example.

### DESCRIPTION OF EMBODIMENTS

The following is a description of an embodiment of a communication device, a communication method, a communication system, and a communication program according to the present invention, with reference to the drawings. Note that the embodiment described below concerns an optical ring network system (corresponding to the communication system) that includes a plurality of optical transmission devices (corresponding to the communication devices) connected via an optical ring network.

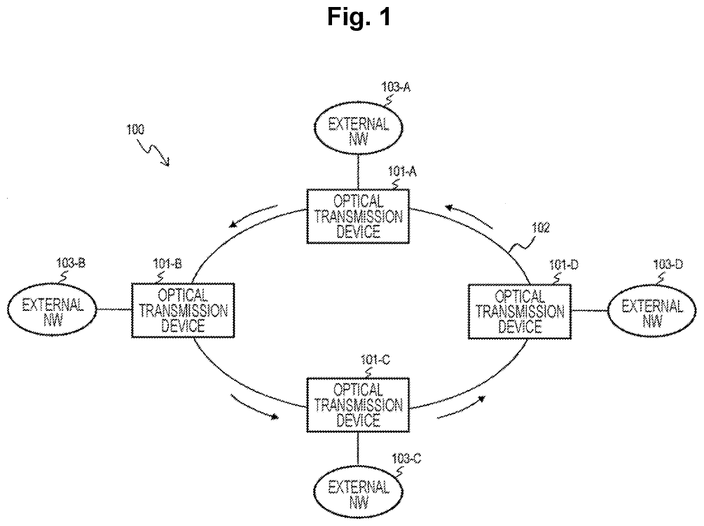

FIG. 1 illustrates an example of an optical ring network system 100 according to the embodiment.

In the example illustrated in FIG. 1, an optical transmission device 101-A, an optical transmission device 101-B, an optical transmission device 101-C, and an optical transmission device 101-D are connected by a ring-like network (an optical ring network 102) formed with optical fibers.

In a case where an explanation common to the optical transmission device 101-A, the optical transmission device 101-B, the optical transmission device 101-C, and the optical transmission device 101-D is made herein, the alphabet at the end of each reference numeral is omitted, and each optical transmission device is referred to as the optical transmission device 101. In a case where a specific device among the plurality of optical transmission devices 101 is described, the specific device is referred to as the optical transmission device 101-A, for example, with an alphabet added at the end of reference numeral. The same applies to an external network (NW) 103-A, an external NW 103-B, an external NW 103-C, and an external NW 103-D.

The external NWs 103 are connected to the respective optical transmission devices 101, and communication between these external NWs 103 can be performed via the optical ring network 102.

The external NWs 103 are NWs connected to the optical ring network system mentioned above, and have NW devices or the like connected thereto.

Here, the optical ring network system 100 according to the embodiment uses an optical burst ring network technology. By this technology, the plurality of optical transmission devices 101 performs time-division multiplexing (optical time division multiple access (TDMA)) on optical signals, to conduct communication in the optical ring network 102. Note that the optical ring network system 100 may be operated with one wavelength, or may be operated by wavelength multiplexing. In the case of wavelength multiplexing, optical signals are subjected to time-division multiplexing for each wavelength.

In FIG. 1, of the plurality of optical transmission devices 101, one optical transmission device 101 operates as the master device (corresponding to the master communication device), and the other optical transmission devices 101 operate as slave devices (corresponding to the slave communication devices). Here, the master device in the initial state is determined in advance. For example, in a case where the optical transmission device 101-A is the master device, the optical transmission device 101-B, the optical transmission device 101-C, and the optical transmission device 101-D are the slave devices.

The optical transmission device 101 as the master device determines the optical signal transmission timings for the optical transmission devices 101 including the master device, and transmits an allocation signal for allocating the optical signal transmission timings to the optical transmission devices 101 as the slave devices. The optical transmission device 101 as the master device also transmits a search signal for detecting an optical transmission device 101 as a slave device newly connected to the optical ring network 102. Note that the allocation signal and the search signal correspond to the control signal transmitted from the master device to the slave devices.

Here, an allocation signal includes information for allocating an optical signal transmission timing. For example, an allocation signal includes information such as a device identifier for identifying the allocation-target optical transmission device 101, a transmission start time indicating the time to start transmitting the optical signal, and a transmission time (transmission duration) indicating the time during which the optical signal is to be transmitted. A search signal includes information such as a transmission start time indicating the time at which the newly connected optical transmission device 101 is to start transmitting a registration request signal for requesting registration to the master device, and a transmission time indicating the time during which the registration request signal is to be transmitted.

An optical transmission device 101 as a slave device transmits an optical signal at the transmission timing allocated by an allocation signal received from the master device. Further, in a case where an optical transmission device 101 as a slave device is newly connected to the optical ring network 102, the optical transmission device 101 transmits a registration request signal to the master device, on the basis of a search signal received from the master device. In this manner, the optical transmission device 101 as a slave device newly connected to the optical ring network 102 can be registered with the master device. After that, the registered optical transmission device 101 as a slave device can transmit an optical signal at the transmission timing allocated by an allocation signal received from the master device.

As described above, in the embodiment, the optical transmission device 101 functioning as the master device controls the timings at which all the optical transmission devices 101 including the master device transmit optical signals, registration of an unregistered optical transmission device 101 to be newly connected, and the like.

(Allocation Signals)

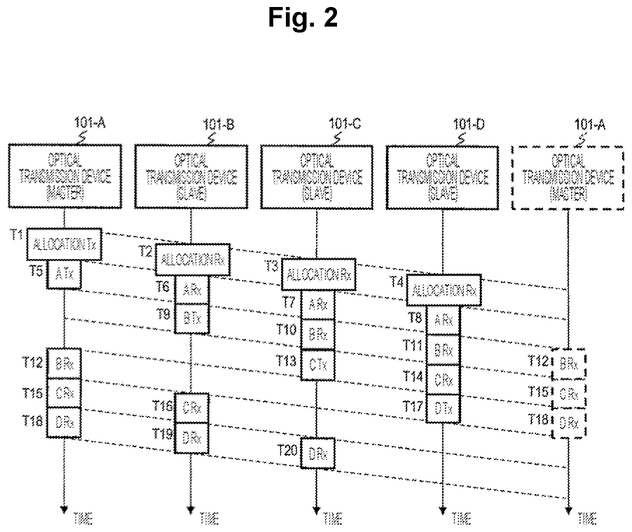

FIG. 2 illustrates example communication of the allocation signals in a case where the master device is the optical transmission device 101-A, and the slave devices are the optical transmission device 101-B, the optical transmission device 101-C, and the optical transmission device 101-D in FIG. 1. Here, “(master)” is added to the optical transmission device 101 functioning as the master device, and “(slave)” is added to each optical transmission device 101 functioning as a slave device, like the optical transmission device (master) 101 and an optical transmission device (slave) 101.

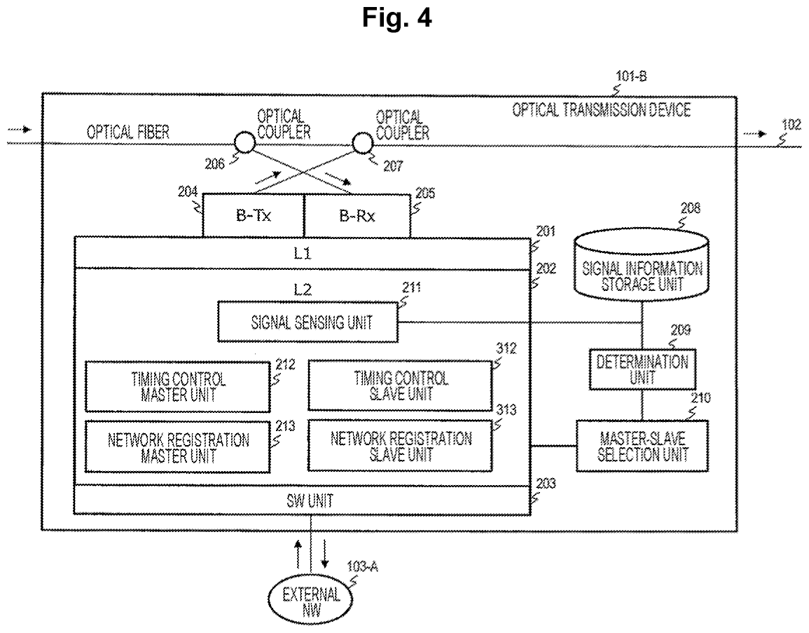

The optical transmission device (master) 101-A transmits an allocation signal (a control signal) for allocating a transmission timing to each optical transmission device (slave) 101 at time T1 (shown as [allocation Tx]). At time T2, the optical transmission device (slave) 101-B then receives the allocation signal (shown as [allocation Rx]). Likewise, the optical transmission devices (slaves) 101-C and 101-D receive the allocation signal at times T3 and T4, respectively. Note that the optical transmission device (master) 101-A also allocates a timing for transmitting a data signal to the master device. In the example in FIG. 4, the data signal transmission timings for the optical transmission devices (master) 101-A, 101-B, 101-C, and 101-D are allocated as T5, T9, T13, and T16, respectively.

The data signal transmitted from the optical transmission device (master) 101-A at time T5 is then received by the optical transmission devices (slaves) 101-B, 101-C, and 101-D at times T6, T7, and T8, respectively. Here, the above operation is represented by T5 [A Tx]->T6 [A Rx]->T7 [A Rx]->T8 [A Rx]. Likewise, the data signal transmitted from the optical transmission device (slave) 101-B at time T9 is received by the optical transmission devices (slaves) 101-C and 101-D and the optical transmission device (master) 101-A at times T10, T11, and T12, respectively. Likewise, the data signal transmitted from the optical transmission device (slave) 101-C at time T13 is received by the optical transmission device (slave) 101-D, the optical transmission device (master) 101-A, and the optical transmission device (slave) 101-B at times T14, T15, and T16, respectively. Likewise, the data signal transmitted from the optical transmission device (slave) 101-D at time T17 is received by the optical transmission device (master) 101-A and the optical transmission devices (slaves) 101-B and 101-C at times T18, T19, and T20, respectively.

As described above, since one of the optical transmission devices 101 connected to the optical ring network 102 operates as the master device, and the master device allocates optical signal transmission timings to all the optical transmission devices 101, communication by time-division multiplexing becomes possible.

(Search Signals)

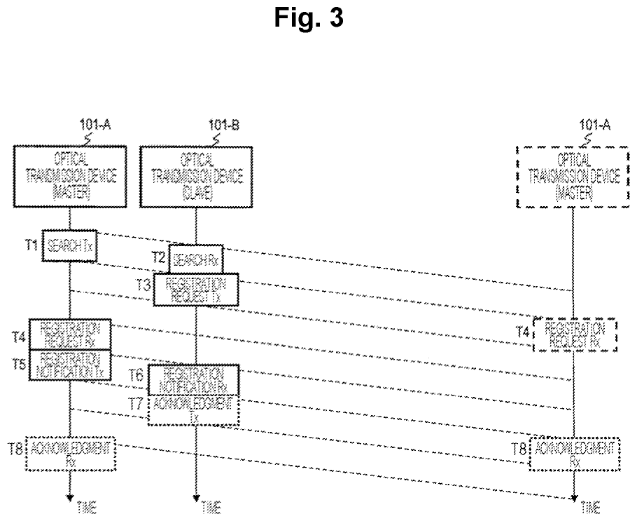

FIG. 3 illustrates example communication of search signals in a case where the master device is the optical transmission device 101-A in FIG. 1. Note that, in FIG. 3, transmission and reception of each signal are shown in the same manner as those in FIG. 2.

At time T1, the optical transmission device (master) 101-A transmits a control signal (referred to as a search signal) for searching for an unregistered optical transmission device (slave) 101-B to be newly connected to the optical ring network 102 (shown as [search Tx]). At time T2, the optical transmission device (slave) 101-B then receives the search signal (shown as [search Rx]). At time T3, which is the transmission start time written in the search signal, the unregistered optical transmission device (slave) 101-B that has received the search signal transmits a control signal (referred to as a registration request signal) for requesting registration to the optical transmission device (master) 101-A. The optical transmission device (master) 101-A that has received the registration request signal at time T4 performs a registration process, and transmits a control signal (a registration notification signal) for issuing a registration notification, to notify the optical transmission device (slave) 101-B that the registration is completed (T5). Note that the optical transmission device (slave) 101-B that has received the registration notification signal at time T6 may transmit an acknowledgement signal indicating that the registration notification signal has been confirmed to the optical transmission device (master) 101-A at time T7, which is the transmission start time written in the registration notification signal. In this case, the optical transmission device (master) 101-A receives the acknowledgement signal at time T8.

In this manner, one of the optical transmission devices 101 connected to the optical ring network 102 operates as the master device, and the master device can transmit a search signal and register the optical transmission device 101 to be newly connected.

Here, in a case where the master device cannot operate properly due to a failure or the like in the optical ring network system 100 illustrated in FIG. 1, any allocation signal and any search signal are not transmitted, and therefore, it is not possible to continue the system operation. To counter this, each optical transmission device 101 according to the embodiment is an optical transmission device 101 as a slave device that has a function of operating as the new master device and being able to continue the system operation in a case where the optical transmission device 101 as the master device cannot operate properly.

(Example Configuration of an Optical Transmission Device 101)

FIG. 4 illustrates an example configuration of the optical transmission device 101-B operating as a slave device in FIG. 2. Here, FIG. 4 illustrates an example configuration of the optical transmission device 101-B, but the optical transmission device 101-C and the optical transmission device 101-D operating as the same slave devices have the same configurations. Note that the optical transmission device 101-A operating as the master device in FIG. 2 also has a function of operating as a slave device.

In this manner, the four optical transmission devices 101 described with reference to FIG. 1 each have the functions of a master device and the functions of a slave device, and choose to operate as a master device or a slave device. For example, the optical transmission device 101 that has selected the functions of a master device operates as the master device, and each optical transmission device 101 that has selected the functions of a slave device operates as a slave device.

In FIG. 4, the optical transmission device 101-B includes a layer-1 processing unit (L1 unit) 201, a layer-2 processing unit (L2 unit) 202, a switch unit (SW unit) 203, an optical transmission unit (B-Tx unit) 204, an optical reception unit (B-Rx unit) 205, an optical coupler 206, an optical coupler 207, a signal information storage unit 208, a determination unit 209, and a master-slave selection unit 210. Further, the L2 unit 202 includes a signal sensing unit 211, a timing control master unit 212, a network registration master unit 213, a timing control slave unit 312, and a network registration slave unit 313. Here, the timing control master unit 212 and the network registration master unit 213 are functions of a master device, and the timing control slave unit 312 and the network registration slave unit 313 are functions of a slave device.

The L1 unit 201 has a function of processing an OSI-reference-model first layer (a physical layer).

The L2 unit 202 has a function of processing an OSI-reference-model second layer (a data link layer). In the embodiment, the L2 unit 202 includes a signal sensing unit 211 described later. The signal sensing unit 211 senses an allocation signal or a search signal from an optical signal received from the optical ring network 102. The L2 unit 202 also has the functions of a master device and the functions of a slave device, and operates with the functions of either device, on the basis of a command from the master-slave selection unit 210 described later. In the case of a master device, the L2 unit 202 performs transmission timing control, and senses and registers an unregistered optical transmission device 101. In the case of a slave device, the L2 unit 202 controls the transmission timing of the optical signal to be transmitted from the B-Tx unit 204 in accordance with the transmission start time and the transmission time designated by the master device, and receives a search signal from the master device to perform registration.

The SW unit 203 is an electric packet switch such as a L2-SW connected to the external NW 103, and has a function of processing a packet transfer between the L2 unit 202 and the external NW 103 in accordance with preset rules.

The B-Tx unit 204 is a transmission unit that intermittently outputs an optical signal, and transmits a signal transferred from the L1 unit 201 as an optical signal to an optical fiber via an optical coupler in a burst manner.

The B-Rx unit 205 is a reception unit that intermittently receives an optical signal, receives an optical signal from an optical fiber in a burst manner via an optical coupler, and transfers the signal to the L1 unit 201. Here, the B-Tx unit 204 and the B-Rx unit 205 correspond to the communication unit.

The optical coupler 206 and the optical coupler 207 each have a function of branching the power of an input optical signal.

The signal information storage unit 208 is formed with a storage medium such as a semiconductor memory. In a case where the subject device to which the signal information storage unit 208 belongs is a slave device, the information written in an allocation signal or a search signal received from the master device is stored in a list format (referred to as a band information list) item by item in the signal information storage unit 208, and can be rearranged item by item by the determination unit 209 described later. For example, in a case where the items in the band information list of an allocation signal are “device identifier, transmission start time, and transmission time”, the list can be rearranged in descending order of transmission start times. Note that, as described above with reference to FIG. 2, an allocation signal contains information for notifying all the optical transmission devices 101 operating as the slave devices connected to the optical ring network 102 of the transmission timings. Thus, each slave device can be notified of the “device identifiers, transmission start times, and transmission times” of the other slave devices.

The determination unit 209 receives a notification of the reception status of an allocation signal or a search signal from the signal sensing unit 211 of the L2 unit 202, and determines the state of the master device. For example, in a case where neither an allocation signal nor a search signal is received in a predetermined period, the determination unit 209 determines that the master device cannot operate properly due to a failure or the like. In a case where the determination unit 209 determines that the master device cannot operate properly due to a failure or the like, the determination unit 209 then determines whether the subject device is to operate as the master device. For example, the determination unit 209 determines whether the subject device should operate as the new master device, on the basis of the band information list of the allocation signal stored in the signal information storage unit 208. Note that the method for determining whether the subject device should operate as the new master device on the basis of the band information list will be described later. The determination unit 209 then instructs the master-slave selection unit 210 that the subject device is to operate as the master device or is to operate as a slave device. Here, the determination as to whether the subject device is to operate as the master device is performed simultaneously in all the optical transmission devices 101 operating as the slave devices connected to the optical ring network 102. Note that, in the embodiment, a process is performed so that a plurality of slave devices does not operate as master devices. This process will be described later with reference to a flowchart.

The master-slave selection unit 210 exclusively controls whether the optical transmission device 101 is to function as the master device or a slave device, on the basis of an instruction from the determination unit 209. In a case where the optical transmission device 101 is to function as the master device, the master-slave selection unit 210 activates the timing control master unit 212 and the network registration master unit 213 of the L2 unit 202. In a case where the optical transmission device 101 is to function as a slave device, on the other hand, the master-slave selection unit 210 activates the timing control slave unit 312 and the network registration slave unit 313 of the L2 unit 202.

The signal sensing unit 211 senses an allocation signal or a search signal from an optical signal received from the optical ring network 102. The signal sensing unit 211 then stores information regarding the sensed allocation signal or search signal into the signal information storage unit 208, and notifies the determination unit 209 of the reception status. Here, the information regarding the allocation signal or search signal includes information such as the device identifier, the transmission start time, and the transmission time. Further, a reception status is information such as the presence/absence of reception of an allocation signal or a search signal, and a reception time, for example.

The timing control master unit 212 operates in a case where the master-slave selection unit 210 causes the subject device to function as the master device. The timing control master unit 212 has a function of determining transmission timings for all the optical transmission devices 101 connected to the optical ring network 102 including the subject device, and gives the subject device (or a slave device) an instruction regarding the time to transmit an optical signal and the duration of transmission. Note that, for the subject device, the timing control master unit 212 controls the transmission timing of the optical signal to be transmitted from the B-Tx unit 204. Instructions regarding the transmission timings for the optical transmission devices 101 other than the subject device are issued through communication performed by the L1 unit 201, the L2 unit 202, the B-Tx unit 204, and the B-Rx unit 205.

The network registration master unit 213 operates in a case where the master-slave selection unit 210 causes the subject device to function as the master device. The network registration master unit 213 executes an initial connection sequence with an unregistered optical transmission device 101, to sense connection of the unregistered optical transmission device 101 to the optical ring network 102 and register the unregistered optical transmission device 101 in the optical ring network system 100. Specifically, the network registration master unit 213 transmits a search signal to search for an unregistered optical transmission device 101 to be newly connected. When receiving a registration request signal from the unregistered optical transmission device 101 in response to the search signal, the network registration master unit 213 then performs a registration process as a connection device to the optical ring network 102, and transmits a registration notification signal to the unregistered optical transmission device 101.

The timing control slave unit 312 operates in a case where the master-slave selection unit 210 causes the subject device to function as a slave device. The timing control slave unit 312 controls the transmission timing of the optical signal to be transmitted from the B-Tx unit 204, in accordance with the transmission start time and the transmission time designated by the master device.

The network registration slave unit 313 operates in a case where the master-slave selection unit 210 causes the subject device to function as a slave device. As described above with reference to FIG. 3, in a case where a search signal is received from the master device, the network registration slave unit 313 transmits a registration request signal to the master device, and receives a registration notification signal transmitted from the master device that has received the registration request signal.

As described above, each optical transmission device 101 according to the embodiment can operate as a master device or a slave device. In a case where the subject device is a slave device, a check is made to determine whether the master device is operating properly, on the basis of the reception status of an allocation signal or a search signal transmitted from the master device. In a case where it is determined that the master device cannot operate properly due to a failure or the like, the subject device or another slave device operates as the master device. Thus, the optical ring network system 100 can have redundancy, and the system operation can be continued.

(Band Information List)

Next, the band information list is described. For example, in a case where the items in the band information list obtained through an allocation signal is “device identifier, transmission start time, and transmission time”, the band information list shown below is stored into the signal information storage unit 208. Here, each item in the band information list can be rearranged by the determination unit 209. Also, s (s being integers) indicates the order in the list. Note that an allocation signal contains information such as the “device identifiers, transmission start times, and transmission times” of all the allocation target devices, and thus, each slave device can be notified of information about the other slave devices.

(Example of the Band Information List)

| s | Device identifier | Transmission start time | Transmission time |
|---|---|---|---|
| 0 | AAA | TA | 10 |
| 1 | BBB | TB | 5 |
| 2 | CCC | TC | 10 |
| 3 | . . . | . . . | . . . |

The band information list is rearranged in descending order of transmission start times. For example, the list is rearranged in the order of TA<TB<TC. In the list with s=0 and the earliest transmission start time, the device identifier is AAA, the transmission start time is TA, and the transmission time is 10. In the list with s=1, the device identifier is BBB, the transmission start time is TB, and the transmission time is 5. In the list with s=2, the device identifier is CCC, the transmission start time is TC, and the transmission time is 10. Note that the transmission start times and the transmission times are indicated on the order of nanoseconds, for example. The determination unit 209 determines whether the subject device is to operate as the new master device, in accordance with the list rearranged in this manner. For example, by determining beforehand that the slave device having the device identifier with the earliest transmission start time is to operate as the new master device, the determination unit 209 can select one new master device from a plurality of slave devices.

(Process of Switching to the Master Device)

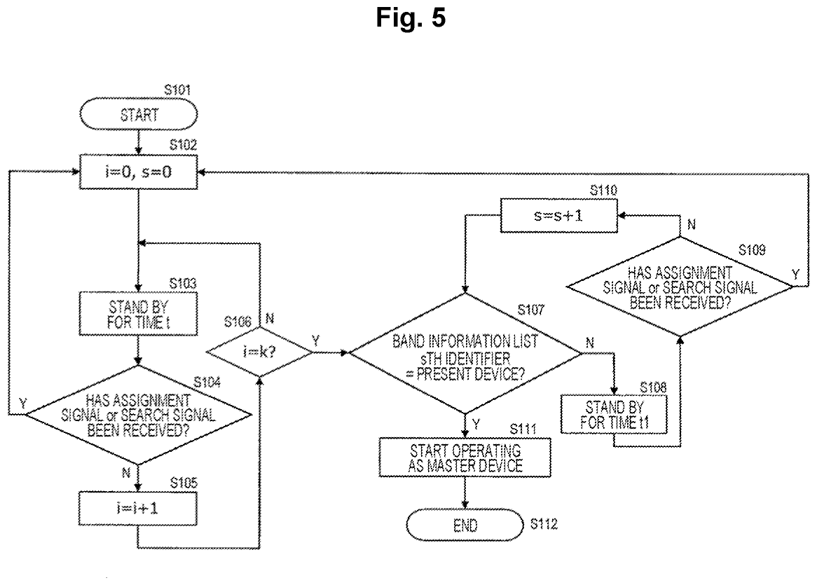

FIG. 5 illustrates an example process of switching to the master device. Here, FIG. 5 illustrates a process to be performed in a case where the optical transmission device 101 operates as a slave device, and the process is performed by the signal information storage unit 208, the determination unit 209, the master-slave selection unit 210, and the signal sensing unit 211 of the optical transmission device 101-B described above with reference to FIG. 4, for example. Note that a program corresponding to the process to be described with reference to FIG. 5 may be performed by a computer or an integrated circuit such as a field programmable gate array (FPGA). Alternatively, the program may be recorded in a storage medium to be provided, or may be provided through a network.

In step S101, the optical transmission device 101 operating as a slave device starts performing a process of determining whether the master device is operating properly.

In step S102, the determination unit 209 resets a counter i and a counter s to 0.

In step S103, the determination unit 209 makes the process to stand by for a preset time t. Here, the time t has a greater value than the time intervals at which the master device transmits allocation signals or search signals.

In step S104, the determination unit 209 checks whether an allocation signal or a search signal has been received from the master device through the signal sensing unit 211. If an allocation signal or a search signal has been received (Y), the process returns to step S102, and the same process is repeated. If neither of the signals has been received (N), the process moves on to the process in step S105. Note that the signal sensing unit 211 stores the received allocation signal or information regarding a search signal into the signal information storage unit 208, and creates the band information list.

In step S105, the determination unit 209 increments the counter i by one, and moves on to the process in step S106.

In step S106, the determination unit 209 determines whether the counter i has reached a preset threshold k (k being an integer). If i=k (Y), the process moves on to the process in step S107. If i<k (N), the process returns to the process in step S103, and the same process is repeated. In the process in this step, a check is made to determine whether an allocation signal or a search signal is to be received in a predetermined period (a period of t×k in the example in FIG. 5). Here, in a case where the counter i has reached the threshold k, the determination unit 209 determines that the master device is able to transmit neither an allocation signal nor a search signal due to a failure or the like, and starts performing a process of determining whether the subject device should operate as the master device.

In step S107, the determination unit 209 refers to the band information list stored in the signal information storage unit 208, performs rearrangement under a predetermined condition, and determines whether the subject device satisfies the condition. For example, the band information list is rearranged in descending order of transmission start times, and a check is made to determine whether the sth device identifier is the identifier of the subject device. If the sth device identifier is the identifier of the subject device (Y), the process moves on to step S111. If the sth device identifier is not the identifier of the subject device (N), the process moves on to step S108. In the example of the band information list described above, the sth=0th device identifier with the earliest transmission start time is AAA. Therefore, if the identifier of the subject device is AAA, the process moves on to step S111, and the subject device starts operating as the master device.

In step S108, the determination unit 209 makes the process to stand by for a preset time t1. Here, time t1 has a greater value than the time required for another slave device to start operating as the master device.

In step S109, the determination unit 209 checks whether an allocation signal or a search signal has been received from the new master device through the signal sensing unit 211. If an allocation signal or a search signal has been received (Y), the process returns to step S102, and the same process is repeated. If neither of the signals has been received (N), the process moves on to the process in step S110.

In step S110, the determination unit 209 increments the counter s by one, and returns to the process in step S107. As the processes from step S107 to step S110 are repeated, one of the slave devices connected to the optical ring network system 100 can be selected, and the selected slave device can reliably start operating as the new master device.

In step S111, since the subject device is selected as the new master device, the determination unit 209 instructs the master-slave selection unit 210 that the subject device is to start operating as the master device.

In step S112, the optical transmission device 101 that has been operating as a slave device starts operating as the master device, and ends the process illustrated in FIG. 5.

As described above, in a case where the subject device is a slave device, the optical transmission device 101 according to the embodiment determines whether the master device is operating properly, on the basis of the reception status of an allocation signal or a search signal transmitted from the master device. In a case where the master device is determined not to be able to operate properly due to a failure or the like, one of the optical transmission devices 101 operating as slave devices starts operating as the master device. Thus, it is possible to make the optical ring network system 100 redundant, and the system operation is continued even when a failure occurs in the master device.

### COMPARATIVE EXAMPLE

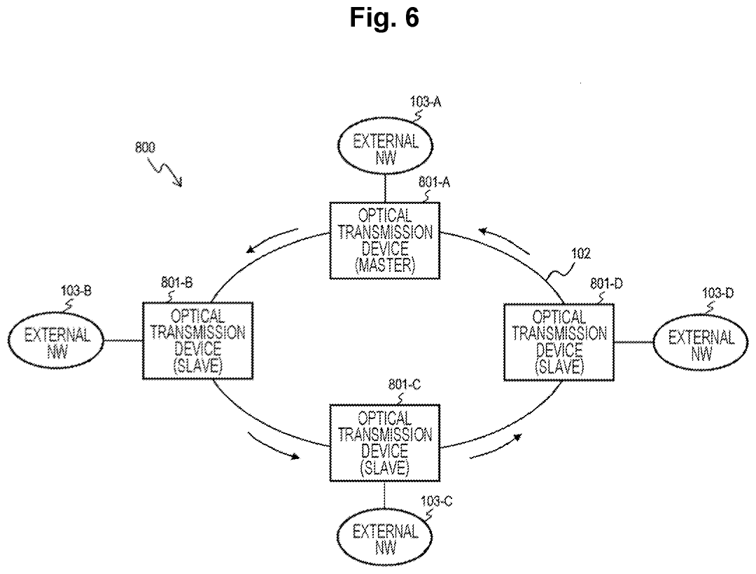

FIG. 6 illustrates an optical ring network system 800 of a comparative example. In the example illustrated in FIG. 6, one optical transmission device (master) 801-A and one or more optical transmission devices (slaves) 801-B to 801-D are connected by an optical ring network 102. Further, external NWs 103-A, 103-B, 103-C, and 103-D are connected to the optical transmission device (master) 801-A and the optical transmission devices (slaves) 801-B to 801-D, respectively.

The optical ring network system 800 of the comparative example in FIG. 6 differs from the optical ring network system 100 according to the embodiment in FIG. 1 in that the optical transmission device 801 to operate as the master device is determined in advance. For example, in the case illustrated in FIG. 6, the optical transmission device 801-A is set as the master device, and the optical transmission devices 801-B, 801-C, and 801-D are set as the slave devices by a maintenance personnel or the like. The optical transmission device (master) 801-A then controls the timings for the optical transmission device (slave) 801-B, the optical transmission device (slave) 801-C, and the optical transmission device (slave) 801-D to transmit optical signals, and also controls new registration and the like. However, in a case where the optical transmission device (master) 801-A cannot operate properly due to a failure or the like, control on the optical signal transmission timings, new registration, and the like is not performed, and the system operation cannot be continued. In this case, it is necessary for the maintenance personnel to repair the optical transmission device (master) 801-A, or to reconfigure one of the optical transmission device (slave) 801-B, the optical transmission device (slave) 801-C, and the optical transmission device (slave) 801-D to operate as the master device.

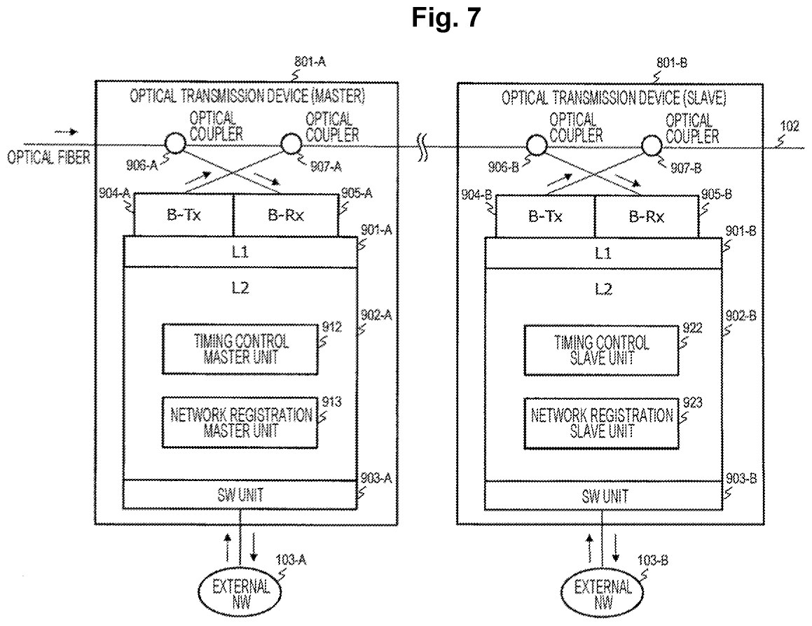

FIG. 7 illustrates an example configuration of the optical transmission device (master) 801-A and the optical transmission device (slave) 801-B illustrated in FIG. 6. Note that the optical transmission device (slave) 801-C and the optical transmission device (slave) 801-D each have the same configuration as the optical transmission device (slave) 801-B.

Here, in FIG. 7, blocks having the same names other than the L2 unit 902-A of the optical transmission device (master) 801-A and the L2 unit 902-B of the optical transmission device (slave) 801-B operate in the same manner as those of the optical transmission device 101-A according to the embodiment illustrated in FIG. 4, and therefore, explanation of them is not repeated herein. For example, the L1 unit 901-A, the SW unit 903-A, the B-Tx unit 904-A, the B-Rx unit 905-A, the optical coupler 906-A, and the optical coupler 907-A of the master device, and the L1 unit 901-B, the SW unit 903-B, the B-Tx unit 904-B, the B-Rx unit 905-B, the optical coupler 906-B, and the optical coupler 907-B of the slave device operate in the same manner as the L1 unit 201-A, the SW unit 203-A, the B-Tx unit 204-A, the B-Rx unit 205-A, the optical coupler 206-A, and the optical coupler 207-A of the optical transmission device 101-A according to the embodiment illustrated in FIG. 4.

Here, in the comparative example, the optical transmission device (master) 801-A is set as the master device in advance, and the optical transmission device (slave) 801-B is set as the slave device in advance. On the other hand, the optical transmission device 101 according to the embodiment in FIG. 4 has a function of sensing a failure in the master device and switching a slave device to the master device.

In FIG. 7, the L2 unit 902-A of the optical transmission device (master) 801-A set as the master device includes a timing control master unit 912 and a network registration master unit 913.

Like the timing control master unit 212 of the embodiment illustrated in FIG. 4, the timing control master unit 912 determines the transmission timings for all the optical transmission devices 801 connected to the optical ring network 102 including the subject device. The timing control master unit 912 then notifies the subject device (or a slave device) of the time to transmit an optical signal and the duration of transmission.

Like the network registration master unit 213 of the embodiment illustrated in FIG. 4, the network registration master unit 913 senses connection of an unregistered optical transmission device (slave) 801 to the optical ring network 102, and registers the unregistered optical transmission device (slave) 801 in the optical ring network system 800.

As described above, the optical transmission device (master) 801-A of the comparative example is designed beforehand to function as the master device.

Meanwhile, the optical transmission device (slave) 801-B set as a slave device in FIG. 7 includes a timing control slave unit 922 and a network registration slave unit 923 in the L2 unit 902-B.

Like the timing control slave unit 312 of the embodiment illustrated in FIG. 4, the timing control slave unit 922 controls the transmission timing of the optical signal to be transmitted from the B-Tx unit 904, in accordance with the transmission start time and the transmission time designated by the master device.

Like the network registration slave unit 313 of the embodiment illustrated in FIG. 4, in a case where a search signal is received from the master device, the network registration slave unit 923 transmits a registration request signal to the master device, and receives a registration notification signal transmitted from the master device that has received the registration request signal.

As described above, each optical transmission device 801 of the comparative example is set as the master device or a slave device in advance. For example, in the case illustrated in FIGS. 6 and 7, the optical transmission device (master) 801-A is set as the master device, and the devices other than the optical transmission device (master) 801-A are slave devices. However, in a case where the optical transmission device (master) 801-A cannot operate properly due to a failure or the like, control on the optical signal transmission timings, new registration, and the like is not performed, and it is not possible to continue the system operation.

On the other hand, each optical transmission device 101 according to the embodiment described above with reference to FIG. 4 has the functions of both a master device and a slave device, and a function of selecting either one to operate as a master device or a slave device. For example, in a case where the functions of a master device are selected, the optical transmission device 101 operates as the master device, and, in a case where the functions of a slave device are selected, the optical transmission device 101 operates as a slave device. Further, in a case where an optical transmission device 101 according to the embodiment checks the state of the master device when operating as a slave device, and the master device cannot operate properly due to a failure or the like, one of the slave devices is automatically switched to the master device, and thus, the system operation can be continued.

As described so far, with a communication device, a communication method, a communication system, and a communication program according to the present invention, a slave device starts operating as the new master device in a case where the master device that controls a plurality of optical transmission devices connected to an optical ring network that conducts communication by performing time-division multiplexing on optical signals cannot operate properly. Thus, the system operation can be continued.

### REFERENCE SIGNS LIST

| | |
|---|---|
| 100, 800 | optical ring network system |
| 101, 801 | optical transmission device |
| 102 | optical ring network |
| 103 | external NW |
| 201, 901 | L1 unit |
| 202, 902 | L2 unit |
| 203, 903 | SW unit |
| 204, 904 | B-Tx unit |
| 205, 905 | B-Rx unit |
| 206, 207, 906, 907 | optical coupler |
| 212, 912 | timing control master unit |
| 213, 913 | network registration master unit |
| 312, 922 | timing control slave unit |
| 313, 923 | network registration slave unit |

1. A communication device comprising:
a communication unit that is connected to an optical ring network, conducts optical signal communication by time-division multiplexing, and receives a control signal for controlling an optical signal transmission timing from a master communication device; and
a determination unit that determines the master communication device not to be operating properly and causes the subject communication device to operate as a new master communication device, when the control signal is not received in a predetermined period.

2. The communication device according to claim 1, further comprising
a storage unit that stores information regarding the control signal containing identifiers of other communication devices including the subject communication device and transmission timings, the information being received from the master communication device,
wherein,
when the determination unit determines the master communication device is not operating properly, the determination unit determines whether the subject communication device is to operate as a new master communication device, on a basis of the identifiers of other communication devices including the subject communication device and the transmission timings, the identifiers and the transmission timings being stored in the storage unit.

3. A communication method that is used in a communication system in which a plurality of communication devices is connected by an optical ring network, one of the communication devices being a master communication device, the other ones of the communication devices being slave communication devices,
wherein
the master communication device transmits a control signal for controlling transmission timings to transmit optical signals to a plurality of the slave communication devices by time-division multiplexing, and
each slave communication device transmits an optical signal to the optical ring network on a basis of a transmission timing of the control signal received from the master communication device, and, when the control signal is not received in a predetermined period, determines the master communication device not to be operating properly, and causes the subject communication device to operate as a new master communication device.

4. The communication method according to claim 3, wherein
the slave communication device stores information regarding the control signal containing identifiers of other communication devices including the subject communication device and transmission timings, the information being received from the master communication device, and, when determining that the master communication device is not operating properly, determines whether the subject communication device is to operate as a new master communication device, on a basis of the stored identifiers of the other communication devices including the subject communication device and the stored transmission timings.

5. A communication system in which a plurality of communication devices is connected by an optical ring network, one of the communication devices being a master communication device, the other ones of the communication devices being slave communication devices,
wherein
the master communication device transmits a control signal for controlling transmission timings to transmit optical signals to a plurality of the slave communication devices by time-division multiplexing, and
each slave communication device transmits an optical signal to the optical ring network on a basis of a transmission timing of the control signal received from the master communication device, and, when the control signal is not received in a predetermined period, determines the master communication device not to be operating properly, and causes the subject communication device to operate as a new master communication device.

6. The communication system according to claim 5, wherein
the slave communication device stores information regarding the control signal containing identifiers of other communication devices including the subject communication device and transmission timings, the information being received from the master communication device, and, when determining that the master communication device is not operating properly, determines whether the subject communication device is to operate as a new master communication device, on a basis of the stored identifiers of the other communication devices including the subject communication device and the stored transmission timings.

7. A communication program for causing a computer or an integrated circuit to perform processes that are performed by the communication device according to claim 1.
